(19) United States
(12) Patent Application Publication
(10) Pub. No.: US 2007/0010915 A1
(43) Pub. Date: Jan. 11, 2007

(54) Weather monitor and irrigation overrride system with unique system identifier

(75) Inventors: Jason Burson, Aubrey, TX (US); Harold Been, Richardson, TX (US)

Correspondence Address: HITT GAINES P.C., P.O. BOX 832570, RICHARDSON, TX, 75083, US

(73) Assignee: Pioneer Sales, Ltd., Dallas, TX (US)

(21) Appl. No.: 11/176,728

(22) Filed: Jul. 7, 2005

(51) Int. Cl. G05D 11/00

(52) U.S. Cl. 700/284; 239/69

(57) ABSTRACT

A weather monitor and irrigation override system for use with an irrigation control system. In a preferred embodiment, the weather monitor and irrigation override system comprises a controller transceiver couplable to an irrigation control system, an environmental sensor, a sensor transceiver coupled to the environmental sensor and configured to wirelessly and bi-directionally communicate with the controller transceiver, and a system identifier module coupled to the controller transceiver having a communications identifier unique to the sensor transceiver and the controller transceiver whereby the controller transceiver accepts wireless transmissions only from the sensor transceiver. A method of manufacturing the weather monitor and irrigation override system is also provided.

### TECHNICAL FIELD OF THE INVENTION

The present invention is directed, in general, to irrigation controllers and, more specifically, to an automated wireless irrigation control system.

### BACKGROUND OF THE INVENTION

Irrigation systems, both commercial and residential, have advanced from the earliest forms employing manual control to clock-driven, pre-programmed timed control (clock timer) by circuit. However, two major problems are encountered by all irrigation systems: freezing ambient temperatures and rainfall overlapping or preceding a programmed watering period. Because of water's property of expanding when frozen, freezing temperatures threaten any exposed plumbing, and may even threaten those portions of buried sprinkler systems commonly referred to as risers and sprinkler heads. Thus, underground irrigation systems generally employ an automatic drain valve at the lowest point of each circuit to drain water in the circuit all the way from the control valve to the sprinkler head, therby preventing freezing.

One prior art device addressed the freezing temperature problem with devices that electrically couple an override control box to the clock timer. The override control box is further electrically coupled to a temperature sensor that provides an instantaneous temperature reading for the control box to act upon. When temperature is sensed to be approaching the freezing point of water, i.e., 32 or 0 , the override control box closes an indoor, electrically-operated water supply valve, thereby preventing additional water from entering the irrigation system. Further, the override control box opens selected sprinkler circuit valves. All of this requires additional wiring between the override control box, the temperature sensor, the indoor water supply valve and the clock timer.

Other prior art devices addressed rainfall detection both for trace amounts of rain and for significant rainfall wherein a trace amount of rain results in a shortened override and significant rainfall results in an extended override. In many systems, prior rainfall is not considered, but the irrigation system is only overridden when rainfall is actually occurring during a pre-set irrigation period. In one system, necessary electrical power was obtained by tapping the output of the clock timer transformer. However, this system was also hard-wired and entirely outdoors, and therefore requires a weathertight box to protect the electrical/electronic parts.

In suburban America, many homes are located in close proximity to one another and many of these homes are equipped with hard-wired automatic sprinkler systems. Frequently a single builder will build out a sub-division of homes, even to installing sprinkler systems in the lawn and landscaped areas. For ease of installation, single suppliers of appliances and equipment are often used for all of the homes, thereby keeping the builder's costs at a minimum. Most of the United States is susceptible to freezing temperatures and certainly receives rainfall, and would therefore benefit from an irrigation override system that would protect the sprinkler system or conserve water. In the close proximity of suburban America, only wired override systems have been practicable as prior art systems using wireless communications for temperature and rainfall override control have ignored the problem of a plurality of override systems within wireless range interfering with one another.

Furthermore, prior art has accepted that information displayed is correct without a means to ascertain if the information is current. Such a configuration introduces uncertainty as to the freshness of the information displayed.

Accordingly, what is needed in the art is a weather monitor and irrigation control system that does not suffer from the deficiencies of the prior art.

### SUMMARY OF THE INVENTION

To address the above-discussed deficiencies of the prior art, the present invention provides a weather monitor and irrigation override system for use with an irrigation control system. In a preferred embodiment, the weather monitor and irrigation override system comprises a controller transceiver couplable to an irrigation control system, an environmental sensor, a sensor transceiver coupled to the environmental sensor and configured to wirelessly and bi-directionally communicate with the controller transceiver. In one embodiment, the weather monitor and irrigation override system further comprises a system identifier module coupled to the controller transceiver having a communications identifier unique to the sensor transceiver and the controller transceiver whereby the controller transceiver accepts wireless transmissions only from the system sensor transceiver. In another embodiment, the weather monitor and irrigation override system further comprises a display transceiver also having the unique communications identifier wherein the display transceiver is configured to wirelessly and bi-directionally communicate only with the controller transceiver. A method of manufacturing the weather monitor and irrigation override system is also provided.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic block diagram of a weather monitor and irrigation override system for use with an irrigation control system constructed in accordance with the principles of the present invention;

FIG. 2A illustrates a front view of one embodiment of the display module of FIG. 1;

FIG. 2B illustrates a back view of the display module of FIG. 1; and

FIG. 3 illustrates a data flow diagram between the environmental sensor, the controller module and the display module.

### DETAILED DESCRIPTION

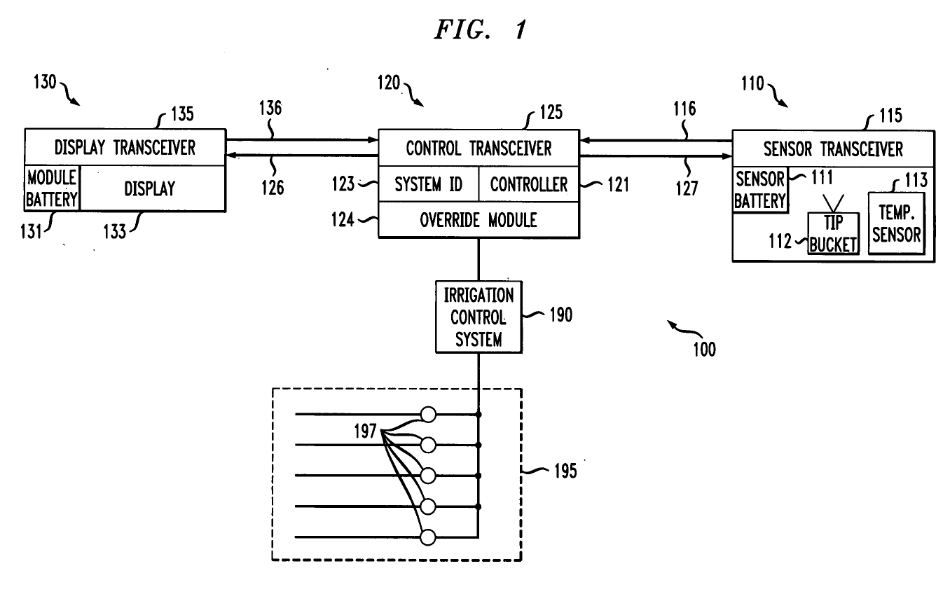

Referring initially to FIG. 1, illustrated is a schematic block diagram of a weather monitor and irrigation override system 100 for use with an irrigation control system 190 constructed in accordance with the principles of the present invention. In the interest of brevity, the weather monitor and irrigation override system 100 will henceforth be referred to as the override system 100. The override system 100 comprises an environmental sensor 110, a sensor transceiver 115, a controller module 120, a controller transceiver 125, a display module 130 and a display transceiver 135. The controller module 120 is electrically couplable to the irrigation control system 190.

The irrigation control system 190 may be a conventional sprinkler system control employing a time and date module, e.g., electronic clock, that activates and deactivates individual circuit valves 197 of an irrigation system 195 according to preset days of the week, times of day, and length of irrigation. One who is of skill in the art is familiar with conventional sprinkler control systems 190. The controller module 120 is configured to interrupt, i.e., override, the irrigation control system 190 by preventing electrical current from flowing to the circuit valves 197 of the irrigation system 195 during times when a preset amount of rain has fallen or an ambient temperature that is below a selected value is sensed by the environmental sensor 110.

The environmental sensor 110 is co-located with the sensor transceiver 115 which are both powered by a sensor battery 111. In one embodiment, the environmental sensor 110 may be a tip bucket 112, i.e., a rain sensor. One who is of skill in the art understands how a tip bucket incrementally measures rainfall. In another embodiment, the environmental sensor 110 may be an electronic temperature sensor 113. One who is of skill in the art is familiar with electronic temperature sensors. In a preferred embodiment, the environmental sensor 110 is both a rainfall sensor 112 and an electronic temperature sensor 113. Of course, other environmental sensors may likewise be used in the present invention. In one embodiment, the sensor battery 111 is a conventional 9 volt battery. Specific types of batteries, e.g., lithium, alkaline, nickel-cadmium, nickel metal hydride, etc., may be preferred in accordance with their expected life when exposed to expected climatic conditions. One who is of skill in the art will be able to appropriately choose an appropriate battery type.

In one embodiment, the controller module 120 comprises a controller 121, a system identification module 123, an override module 124 and the controller transceiver 125. In a preferred embodiment, the controller 121 is the “brain” of the override system 100 as will be shown below. The controller transceiver 125 performs bi-directional communications at radio frequencies with both the sensor transceiver 115 and the display transceiver 135 as required. The system identification module 123 enables specific coding to be allocated to the modules 110, 120, 130 of the override system 100 so that neighboring override systems within radio frequency range do not interfere with the current system nor vice versa.

In a preferred embodiment, the display module 130 comprises the display transceiver 135 and the display 133 and both are powered by a display module battery 131. In one embodiment, the display module battery 131 is a conventional 9 volt battery. Specific types of batteries, e.g., alkaline, nickel-cadmium, lithium, nickel metal hydride, etc., may be preferred in accordance with their expected life. The display module 130, being battery-powered, is portable, and may be placed in any convenient location within a building proximate the irrigation control system 190 and within radio frequency range of the controller module 120. Details of the display module 130 are discussed below. Additionally, the display module 130, being completely portable, may be carried to the vicinity of the irrigation control system 190 to facilitate testing of individual circuit valves 197 or the entire system 100.

In a preferred embodiment, the controller transceiver 125 communicates bi-directionally 127, 116 with the sensor transceiver 115 at radio frequencies as required. The controller transceiver 125 also communicates bi-directionally 126, 136 with the display transceiver 135 at radio frequencies as required. However, other suitable wireless communications, e.g., infrared, ultrasonic, etc., could also be used depending upon acceptable system limitations imposed by the type of wireless communication selected. One who is of skill in the art will understand the capabilities and limitations of the various short-range wireless communications systems. The controller module 120 acts as the brain of the override system 100 by sending information to and receiving information from both the display transceiver 135 and the sensor transceiver 115. In a preferred embodiment, the controller module 120 draws electrical power for its operation from the electrical power system provided with the conventional irrigation control system 190. Conventional irrigation control systems 190 customarily operate on 24 VAC obtained through use of a step-down transformer powered by conventional 110-115 VAC line voltage. Alternatively, the controller module 120 may have its own power transformer or operate on conventional line voltage.

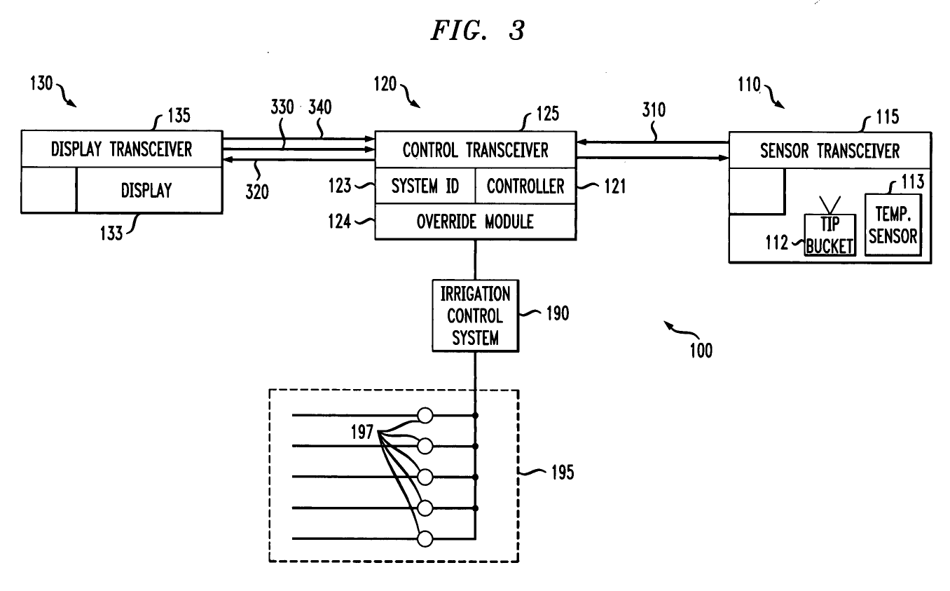

Referring now to FIGS. 2A and 2B, illustrated are front and back views, respectively, of one embodiment of the display module 130 of FIG. 1. The display module 130 comprises a display area 210, a control button area 220, a battery compartment door 230, and a mounting support panel 240. The display module 130 is wireless and operates within about 300 feet of the controller module 120 (see FIG. 1) if no significant structural interferences, e.g., steel, exist. The display module 130 can stand substantially upright on a desk or tabletop by pulling out the hinged mounting support panel 240, or may be mounted on a wall using screws to cooperate with keyholes 241 in the mounting support panel 240. The 9V display module battery 131 (see FIG. 1) is installed or changed by removing the battery compartment door 230 and connecting the display battery 131 to the snap terminals (not shown) in a conventional manner.

The control button area 220 comprises a time set button 221, a date set button 222, a delay set button 223, a temperature set button 224, a rain set button 225, a scroll down button 226, and a scroll up button 227. Various parameters for the system are set using the control buttons 221-227 in conjunction with information shown in the display area 210. Before describing the parameters and how to set them, the display area 210 will be discussed. Preset at the factory within the override system 100 is a unique system identifier (not shown). Each packet of communication between the sensor, controller and display transceivers 115, 125, 135 contains the system identifier. Thus, the sensor module 110, controller module 120 and display module 130 are able to identify radio frequency transmissions and distinguish those emanating only from the instant system; thereby ignoring transmissions from neighboring systems that would have a different system identifier, and yet are within wireless range.

The display area 210 comprises a rain level display 211, a temperature display 212, a date/time display 213, a station ID/year display 214, a sensor module low battery indicator 215, a display module low battery indicator 216, a no-signal indicator 217, a freeze indicator 218, a rain indicator 219, an inches vs millimeters indicator 231, a vs indicator 232, and an AM vs PM time indicator 233. In a preferred embodiment, the rain level display 211, temperature display 212, date/time display 213, and station ID/year display 214 are liquid crystal displays (LCD).

When setting any parameter for the system, the parameter being set will flash and pressing the scroll down button 226 or the scroll up button 227 once will incrementally change the parameter currently being set. Holding down the scroll down button 226 or the scroll up button 227 for more than 5 seconds will put the current parameter being set into a rapid-setting mode and the current parameter will decrement or increment much faster than normal. Releasing the scroll down button 226 or scroll up button 227 exits the rapid-setting mode. The scroll down button 226 and the scroll up button 227 can be used as required until the desired parameter is set. The parameter being set is accepted into the system when neither the scroll down button 226 nor the scroll up button 227 have been pressed for 5 seconds. The current parameter display will cease to flash at that time. Pushing the scroll up button 227 when no parameter is being set will cause the display module 130 to retrieve the previous day's total rainfall from the controller module 120. Pushing the scroll down button 226 when no parameter is being set will cause the display module 130 to retrieve all of its readings and settings from the controller module 120 by sending a command 136 to the controller transceiver 125 to update the readings and settings. The controller transceiver 125 sends the readings and settings 126 to the display transceiver 135 for display by the display 133.

The time display 213 is set by first pressing the time set button 221. The date/time display 213 will flash on and off with the current time in the system clock (not shown). The correct time may then be set as described above using the scroll down button 226 and the scroll up button 227. Each time that the time is set on the display module 130, the display module 130 transmits the new time to the controller module 120 as a command 136. The date of the date/time display 213 is set by first pressing the date set button 222. The date/time display 213 will flash on and off with the current date in the system clock. The correct date may then be set as described above using the scroll down button 226 and the scroll up button 227. As with setting the time, each occasion that the date is set on the display 133, the display module 130 transmits the new time as a command 136 to the controller module 120. During normal operation, the date/time display 213 automatically alternates every 30 seconds between displaying the current system date and the current system time.

A rainfall lockout amount, i.e., the amount of rain that must fall to cause the override system 100 to override the irrigation control system 190, is set by first pressing the rain set button 225. The rain level display 211 and the inches portion of the inches (in) vs millimeters (mm) indicator 231 will flash on and off. The system 100 may now be set to display rainfall in millimeters by pressing the rain set button 225 again making the mm indicator 231 flash. This will also set the vs indicator 232 to read in. The rainfall lockout amount may then be set as described above using the scroll up button 227 and the scroll down button 226. When the scroll up button 227 and the scroll down button 226 have not been pressed for 5 seconds, the override system 100 will have accepted the rainfall lockout amount. To verify that the override system 100 has the correct rainfall lockout amount, pressing the rain set button 225 once will display the currently set rainfall lockout amount in the rain level display 211. In one embodiment, the rain level display 211 is re-set to zero at midnight of each day. However, the previous day's total rainfall is retained in memory for display on command by pressing the scroll up button 227. This enables the override system 100 to reflect daily rainfall as it accumulates. Thus, total rainfall that has occurred that day before a pre-set irrigation time is considered by the controller 121 when the irrigation system 190 must be overridden or allowed to irrigate. Additionally, the controller 121 downwardly adjusts the length of time for irrigation during a pre-set irrigation time that follows rainfall occurring since the previous midnight. This prevents overwatering by the irrigation system when significant rainfall has already occurred.

A temperature lockout value, i.e., the low temperature that must occur to cause the override system 100 to override the irrigation control system 190, is set by first pressing the temperature set button 224. The current setting of the temperature display 212 and the portion of the vs indicator 232 will flash on and off. If not previously set, the display module 130 may now be set to display temperature in by pressing the temperature set button 224 again making the indicator flash. The temperature lockout value may then be set as described above using the scroll up button 227 and the scroll down button 226. When the scroll up button 227 and the scroll down button 226 have not been pressed for 5 seconds, the override system 100 will have accepted the temperature lockout value. To verify that the override system 100 has the correct temperature lockout value, pressing the temperature set button 224 once will display the currently set temperature lockout value in the temperature display 212. During normal operation, the current temperature at the rain/temperature sensor 112, 113 is displayed.

A time delay or lockout period, i.e., the amount of time in hours that the irrigation control system 190 will be disabled after a rain or temperature event occurs, is set by first pressing the delay set button 223. The current setting of the time delay will flash on and off in the time display 213. The time delay amount may then be set as described above using the scroll up button 227 and the scroll down button 226. When the scroll up button 227 and the scroll down button 226 have not been pressed for 5 seconds, the override system 100 will have accepted the time delay amount. To verify that the override system 100 has the correct time delay amount, pressing the delay set button 223 once will display the currently set time delay amount in the time display 213. Setting the time delay or lockout period to zero (0) disables the override system's 100 ability to block the irrigation control system 190 while still allowing total rainfall and temperature to be displayed on the display module 130.

Provision is made to alert the user to a weakening state of the batteries that power the battery-powered modules 110, 130. The sensor module low battery indicator 215 blinks when the sensor module battery 111 is in a low state of charge. When the sensor module battery 111 is dead, the sensor module low battery indicator 215 stays on steady. In a like manner, the display module low battery indicator 216 blinks when the display module battery 131 is in a low state of charge, i.e., a voltage of about 6 V. When the display module battery 131 is dead, i.e., a voltage of about 5 V, the display module low battery indicator 216 stays on steady. When the display module battery 131 is dead, i.e., a voltage of less than about 3 V, the entire display area 210 goes blank. However, the last values within the override system 100 are written to flash memory before the display module battery 131 dies and the display area 210 goes blank. The no-signal indicator 217 illuminates when the display module 130 is not receiving a signal from the controller transceiver 125. In a like manner, the rain level display 211 and the temperature display 212 will not appear if the controller module 120 has not received a signal, i.e., data packet, from the sensor module 110. The freeze indicator 218 illuminates when the override system 100 has disabled the irrigation control system 190 due to the occurrence of a temperature at or below the set temperature. Similarly, the rain indicator 219 illuminates when the override system 100 has disabled the irrigation control system 190 due to the override system 100 sensing rainfall greater than the rainfall lockout amount currently set.

The station ID/year display 214 is designed to enable a plurality of environmental sensor modules 110 to be integrated with a single display module 130. The station identifier display 214 indicates which of a plurality of environmental sensors 110 is supplying the data displayed by the display module 130. Thus, a plurality of sensor modules 110 may be installed within range of the controller module 120 and sequentially supply information for the display module 130 and control of the irrigation system 190. In applications where only one environmental sensor module 110 is employed within the override system 100, the station ID/year display 214 can be used to display the current year when the date/time display 213 is displaying the date.

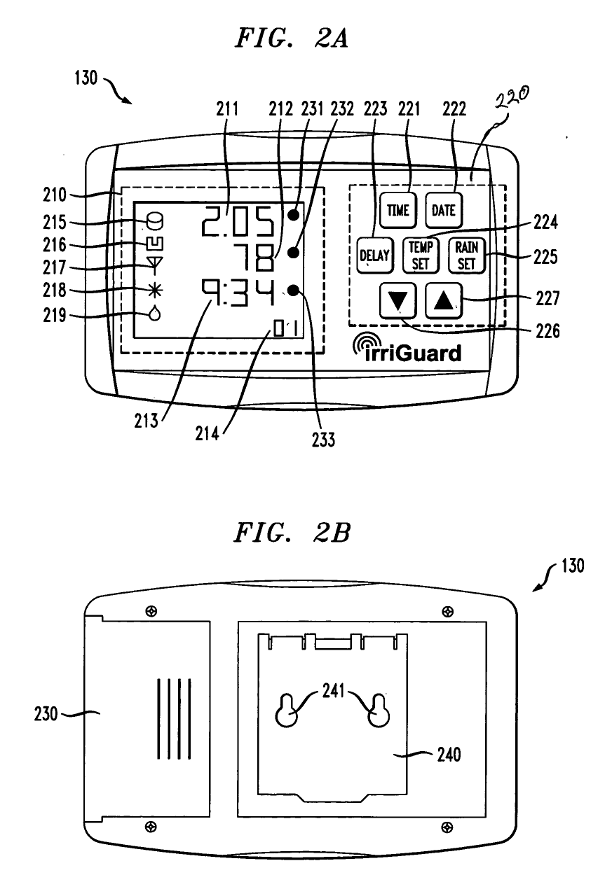

Referring now to FIG. 3 with continuing reference to FIGS. 1 and 2, illustrated is a data flow diagram 300 between the environmental sensor 110, the controller module 120 and the display module 130.

When the override system 100 has been fully programmed with date, time, set temperature, and set rainfall, the sensor transceiver 115 transmits a sensor data packet 310 to the controller transceiver 125 whenever the sensed ambient temperature T_{c} or incremental rainfall RFᵢ changes. In a preferred embodiment, as the ambient temperature changes in the vicinity of the temperature sensor 113, the sensor transceiver 115 transmits the sensor data packet 310 indicating the current ambient temperature T_{c} to the controller transceiver 125. The sensor data packet 310 comprises a system identifier, current ambient temperature T_{c} sensed at the temperature sensor 113, and incremental rainfall RFᵢ, if any, sensed at the rainfall sensor 112. If the sensor battery 111 is weakening, the sensor battery status is included in the sensor data packet 310. The information in the sensor data packet 310 is relayed to the system identification module 123 from the controller transceiver 125 by the controller 121. The sensor data packet 310 is first examined by the system identification module 123 to confirm that the sensor data packet 310 has originated from a sensor within the instant system. Then, if there has been incremental rainfall, the controller 121 updates the total rainfall RF_{T} since the previous midnight. The controller module 120 stores the current temperature T_{c} as relayed from the sensor transceiver 115 through the controller transceiver 125. The controller 121 then directs the controller transceiver 125 to send a controller-to-display data packet 320 comprising the system identifier, current temperature T_{c} and current total rainfall RF_{T}. Alternatively, if a change has occurred only in the current temperature T_{c} since the last sensor data packet 310 was received from the sensor transceiver 115, the controller 121 directs the controller transceiver 125 to send a controller-to-display data packet 320 comprising the system identifier, current temperature T_{c} and current total rainfall RF_{T}. The display transceiver 135 receives the current total rainfall RF_{T} and current temperature T_{c} from the display transceiver 135 and displays the same in the rain level display 211 and the temperature display 212, respectively.

When the date or time is set on the display module 130 as described above, the display module 130, via the display transceiver 135 and the controller transceiver 125, sends a display-to-controller data packet 330 comprising the system identifier and the new date/time to the controller module 120. Furthermore, whenever the display unit 130 is operating normally, i.e., a parameter is not then being set, pressing the scroll up button 227 or the scroll down button 226 causes the display transceiver 135 to send an interrogation data packet 340 to the controller transceiver 125. The interrogation data packet 340 comprises the system identifier and a request for the current status of all system internal and external information displayed in the display area 210, i.e., current rain level, current temperature, current date and time, station ID/year, sensor module low battery, freeze indication, and rain indication. The controller transceiver 125 responds by sending a controller-to-display data packet 320 comprising the system identifier and the requested information.

Refer now once again to FIG. 1. If the total rainfall RF_{T} equals or exceeds the rainfall lockout amount stored by the controller 121, the controller 121 directs the override module 124 to override the circuit valves 197 of the irrigation system 195 for a period of time equal to the time delay amount previously set in the controller 121. As the current to operate the circuit valves 197 is routed through the override module 124, the override is accomplished by preventing current flow from the irrigation control system 190 to the individual circuit valves 197 thus conserving irrigation water. In a similar manner, if the current ambient temperature T_{c} equals or is less than the temperature lockout value stored by the controller, the controller 121 directs the override module 124 to override the circuit valves 197 of the irrigation system 195 until the current ambient temperature T_{c} is above the temperature lockout value stored by the controller 121, thus protecting the irrigation system 190 from freezing conditions.

Thus, a weather monitor and irrigation override system has been described. In one embodiment, the override system comprises a system identifier module that checks all inter-module communications to assure that the communication is from a transceiver that is part of the system, and not from a similar, nearby transceiver. When total rainfall equals or exceeds a set amount, the system overrides the conventional irrigation control system for a set period of time. When current ambient temperature at a remote sensor falls at or below a set temperature lockout value, the system overrides the conventional irrigation control system until the temperature rises above the set temperature lockout value.

Although the present invention has been described in detail, those skilled in the art should understand that they can make various changes, substitutions and alterations herein without departing from the spirit and scope of the invention in its broadest form.

What is claimed is:

1. For use with an irrigation control system, a weather monitor and irrigation override system, comprising:
a controller transceiver couplable to an irrigation control system;
an environmental sensor; and
a sensor transceiver coupled to said environmental sensor and configured to wirelessly and bi-directionally communicate with said controller transceiver.

2. The weather monitor and irrigation override system as recited in claim 1 further comprising a system identifier module coupled to said controller transceiver having a communications identifier unique to said sensor transceiver and said controller transceiver whereby said controller transceiver accepts wireless transmissions only from said sensor transceiver.

3. The weather monitor and irrigation override system as recited in claim 2 further comprising a display transceiver having said unique communications identifier wherein said display transceiver is configured to wirelessly and bi-directionally communicate only with said controller transceiver.

4. The weather monitor and irrigation override system as recited in claim 3 further comprising a display module coupled to said display transceiver, wherein said display module is configured to accept instructions and to display a status of said weather monitor and irrigation override system.

5. The weather monitor and irrigation override system as recited in claim 4 wherein said display module further comprises a no-signal indicator configured to indicate that the display module is not receiving a signal from said controller transceiver.

6. The weather monitor and irrigation override system as recited in claim 4 wherein said display module further comprises a station identifier configured to indicate which of a plurality of environmental sensors is supplying data displayed by said display module.

7. The weather monitor and irrigation override system as recited in claim 4 wherein said display module includes a display module low battery indicator.

8. The weather monitor and irrigation override system as recited in claim 3 further comprising an override module couplable to said irrigation control system and said controller transceiver, said override module configured to override said irrigation control system.

9. The weather monitor and irrigation override system as recited in claim 8 further comprising a controller module coupled to said controller transceiver and said override module.

10. The weather monitor and irrigation override system as recited in claim 1 wherein said environmental sensor is a temperature sensor or a rain sensor.

11. The weather monitor and irrigation override system as recited in claim 1 wherein said controller transceiver and said sensor transceiver are radio frequency transceivers.

12. A method of manufacturing a weather monitor and irrigation override system for use with an irrigation control system, comprising:
providing a controller transceiver couplable to an irrigation control system;
providing an environmental sensor;
coupling a sensor transceiver to said environmental sensor and configuring said sensor transceiver to wirelessly and bi-directionally communicate with said controller transceiver.

13. The method as recited in claim 12 further comprising coupling a system identifier module to said controller transceiver, said system identifier module having a communications identifier unique to said sensor transceiver and said controller transceiver whereby said controller transceiver accepts wireless transmissions only from said sensor transceiver.

14. The method as recited in claim 13 further comprising providing a display transceiver having said unique communications identifier and configuring said display transceiver to wirelessly and bi-directionally communicate only with said controller transceiver.

15. The method as recited in claim 14 further comprising coupling a display module to said display transceiver and configuring said display module to only accept instructions from and to display a status of said weather monitor and irrigation override system.

16. The method as recited in claim 15 further comprising configuring said display module with a no-signal indicator configured to indicate that said display module is not receiving a signal from said controller transceiver.

17. The method as recited in claim 16 further comprising configuring said display module with a station identifier configured to indicate which of a plurality of environmental sensors is supplying data displayed by said display module.

18. The method as recited in claim 15 further comprising configuring said display module with a display module low battery indicator.

19. The method as recited in claim 14 further comprising coupling an override module to said irrigation control system and said controller transceiver, and configuring said override module to override said irrigation control system.

20. The method as recited in claim 19 further comprising coupling a controller module to said controller transceiver and said override module.

21. The method as recited in claim 13 wherein providing an environmental sensor includes providing a temperature sensor or a rain sensor.

22. The method as recited in claim 13 wherein coupling a sensor transceiver includes coupling a radio frequency sensor transceiver.
